(19) United States
(12) Patent Application Publication
(10) Pub. No.: US 2012/0276500 A1
(43) Pub. Date: Nov. 1, 2012

(54) ROOT CANAL INSTRUMENT AND METHOD OF MAKING THE ROOT CANAL INSTRUMENT

(76) Inventors: Werner Mannschedel, Langenau (DE); Barbara Müller, Langenau (DE)

(21) Appl. No.: 13/462,877

(22) Filed: May 3, 2012

Related U.S. Application Data
(63) Continuation of application No. 11/487,960, filed on Jul. 17, 2006.

(30) Foreign Application Priority Data
Jul. 18, 2005 (DE) 10 2005 034 010.5

(51) Int. Cl. A61C 5/02; B23P 17/04

(52) U.S. Cl. 433/102; 29/459

(57) ABSTRACT

A root canal instrument includes a twisted strip having a titanium-nickel alloy or a plastics material. The strip has a cross-section having three exterior surfaces or four exterior surfaces. A coating is disposed on at least one exterior surface, the coating includes abrasive particles. A method of making the root canal instrument includes making a basic plate having a thickness of less than one millimeter, coating the basic plate with a coating having the abrasive particles; dividing the basic plate into longitudinally extended strips, twisting the strip to form a root canal drill bit having a cutting edge with abrasive particles disposed on the cutting edge.

### CROSS-REFERENCE TO RELATED APPLICATIONS

This application is a continuation of and claims priority to U.S. Ser. No. 11/487,960, filed Jul. 17, 2006, which is pending, and which is hereby incorporated by reference in its entirety for all purposes.

U.S. Ser. No. 11/487,960 claims priority to German Patent Application No. DE 10 2005 034 010.5 filed Jul. 18, 2005.

### BACKGROUND OF THE INVENTION

1. Field of the Invention The invention relates to a root canal instrument which has a core of a flexible elastic material having shape memory and which has a coating with abrasive particles on the core.

2. Discussion of the Related Art

A root canal instrument of such a kind is known from the publication U.S. Pat. No. 4,190,958.

From that publication it is furthermore known that, in contrast to customary, very thick and inflexible dental drill bits, endodontic root canal instruments are very thin with a diameter of less than half a millimetre and are very flexible in order to be able to follow the curvature of the root canal in a tooth. There is accordingly proposed in that publication a drill bit which is made from a flexible elastic material having shape memory so that it returns to a straight position from a curved position, assumption of the curved position being necessary in order to be able to follow the curved root canal. In addition, it must have this shape memory while rotating in the curved position.

The material proposed for the core in that publication is a standard material of a carbon-containing chromium steel, which is provided with a diamond coating. The abrasive particles of the diamond coating are fixed in an adhesion-producing agent which is electrolytically deposited or sintered or produced by standard methods.

A disadvantage of a root canal instrument of such a kind is that, in the case of a small diameter of only about half a millimetre, a carbon-containing chromium steel wire coated with an electrolytically deposited or sintered adhesion-producing agent becomes so rigid that, despite its having a core of a flexible elastic material, it is not able to follow the curvature of root canals. It has therefore not been possible for such root canal instruments having an elastic core and a relatively rigid coating of diamond particles to become established in practice, because coating over a length of about from 10 to 12 mm on the core with an electrolytically deposited or sintered diamond-containing adhesion-producing agent practically takes away all the flexibility of a thin chromium steel wire.

Since 1998, new instruments made of nickel-titanium alloys have been used in endodontistry. This material comprises about 55% by weight nickel and about 45% by weight titanium, it being possible for a small proportion of the nickel, about 2% by weight, to be replaced by cobalt or aluminium. In their stress-strain behaviour, the nickel-titanium alloys exhibit so-called superelasticity because, in addition to the Hooke's elasticity of the chromium carbon steels known from the publication U.S. Pat. No. 4,190,958, they have substantial shape memory which is not known in the case of chromium carbon steels. This shape memory results from the fact that this material, which was still entirely unknown in 1978, the year of filing of the publication U.S. Pat. No. 4,190,958, is capable of switching, in the event of deformation, from an austenitic structure to a partly martensitic structure and, when unloaded, of re-establishing the originally austenitic structure at room temperature and, with that, the original shape.

Therefore, root canal instruments for endodontistry are shaped from twisted strips or rods of that new kind of alloy by grinding or machining However, this alloy too has disadvantages. The Vickers hardness HV of the alloy, at 303-362 HV, is, compared to carbon-containing chromium steel at 522-542 HV, almost one third less than carbon-containing chromium steel. It is therefore recommended in the prior art that, because of their greater cutting performance, steel instruments be used in regions where flexibility of the root canal instruments is not required. The limited rates of material removal due to the lower Vickers hardness have to be taken into account, however, in the case of root canal instruments made of nickel-titanium. In addition, root canal instruments made of nickel-titanium are usually used with torque-limited drive means in order to prevent the increased risk of breaking in the event of overloading. There is accordingly a need on the one hand to broaden the area of use of such endodontic instruments and on the other hand to eliminate the lack of sufficient hardness.

The problem of the invention is to provide a root canal instrument which has a core of a flexible elastic material having shape memory and which has a coating with abrasive particles on the core but which overcomes the disadvantages in the prior art in respect of becoming rigid and the problem of the lower cutting and drilling performance of root canal instruments based on nickel-titanium alloys.

### SUMMARY OF THE INVENTION

In accordance with the invention, there is provided a root canal instrument which has a core of a flexible elastic material having shape memory and which has a coating with abrasive particles on the core. For the purpose, either the core is made from a nickel-titanium alloy or it comprises a plastics material, preferably a carbon-fibre-reinforced plastics material. In addition, the flexibility of the coating with abrasive particles is matched to the flexibility of the core.

This flexibility of the coating can be achieved by adhesion-producing agents, in which the abrasive particles are anchored, the adhesion-producing agents themselves having high flexibility and consequently being able to follow the changes in shape of the core of flexible elastic material. For the purpose, rubber-elastic or elastomeric plastics materials, for example based on silicone, are suitable, the abrasive particles on the one hand being held therein and on the other hand projecting sufficiently far out from the adhesion-producing mass that they can perform a cutting function.

As abrasive particles there are used preferably diamond particles and/or ceramic particles such as corundum particles and/or boron nitride particles and/or boron carbide particles and/or silicon particles and/or silicon nitride particles and/or silicon carbide particles. Whereas hard particles such as diamond particles are preferably used for root canal instruments for cutting and grinding, softer particles such as cerucides, iron oxides and/or chalk particles are used as polishing agents.

In the case of an electrolytically deposited rigid adhesion-producing mass, for example of bronze, or a sintered rigid adhesion-producing mass, for example of sintered aluminium masses, the core is provided to have coated and uncoated regions in alternating manner, preferably in periodically alternating manner, so that adhesion-producing masses that are structured in regions, for example in the manner of a link chain or spiral, with abrasive particles are applied so that the regions that are free of coating retain the flexibility of the root canal instrument.

For the purpose, the root canal instrument can preferably be structured so that it has a core of the nickel-titanium alloy or of an electrically conductive plastics material, preferably of a carbon-fibre-reinforced electrically conductive plastics mass, which core has a structured metal coating as anchoring adhesion-producing mass with abrasive particles. As a result of the structuring of the metal coating, which preferably consists of bronze, the above-mentioned flexibility is retained, because the structured metal coating is restricted solely to partial regions of the surface of the flexible elastic core of the root canal instrument. This metal coating as anchoring adhesion-producing mass for the abrasive particles can both be electrodeposited on a core of the nickel-titanium alloy, which has good electrical conductivity, or can also be produced on a core of a plastics mass to which electrically conductive particles, such as silver particles, have been added.

If such cores of an electrically conductive material are not available, it is possible to use, on a core of plastics material such as carbon-fibre-reinforced plastics material, preferably an adhesion-producing mass made from plastics material instead of the electrodeposited metal coating. This adhesion-producing mass of plastics material can simultaneously hold together the fibres of the core, such as carbon fibres, and anchor the abrasive particles in the plastics mass, part of the abrasive particles projecting out from the outer surface of the root canal instrument.

This is achieved by means of the fact that the fibre-containing core is compressed in an extrusion method with supply of an extrudable mixture of plastics material and abrasive particles in injection-moulding to form a composite component. Subsequently, the tips of the abrasive particles can be exposed, for example by removal of material by laser or dissolution, in such a manner that the abrasive particles remain anchored in the plastics material. The flexibility of the embedding plastics material for the core is, in the process, advantageously matched to the flexibility of the core without the need for coating-structuring measures, which are needed in the case of the above-mentioned metallic adhesion-producing masses.

In addition, injection-moulding or extrusion of a mixture of plastics material and abrasive particles (9) can be carried out. Subsequently, the tips of the abrasive particles (9) can be freed of the plastics material. Alternatively, by means of co-extrusion or two-stage injection-moulding, the plastics core can be sheathed in a mixture of plastics material and abrasive particles (9) and subsequently the tips of the abrasive particles (9) can be freed of the plastics material.

In a preferred embodiment of the invention, at least the proximal end of the core is uncoated. This has the advantage that the root canal element follows the curvature of the root canal, and the uncoated proximal end is directed by the surrounding dental cementum of the root canal and does not bore its way out of the root canal through the surrounding tooth cementum. The uncoated proximal end accordingly guides the root canal instrument automatically along the softer tissue of the root canal without damaging the surrounding harder dental cementum. It is only by means of the abrasive coating that follows on from the proximal end of the root canal instrument that the dental cementum is processed, subjected to removal of material or polished, depending on the size and nature of the particles used.

In a further preferred embodiment of the invention, the core has, on its outer surface, a coating of an adhesive, in which the abrasive particles are anchored and out from which the abrasive particles project. A coating of an adhesive of such a kind has the advantage that abrasive particles can be held on the outer surface of the core irrespective of the material of the core. This means that a layer of an adhesive of such a kind with abrasive particles can be applied both on top of a core of a nickel-titanium alloy and on top of a core of plastics material, especially of glass-fibre-reinforced or carbon-fibre-reinforced plastics material.

In a further preferred embodiment of the invention, the core comprises carbon fibres embedded in an adhesion-producing mass of polypropylene, polyethylene or epoxy resin, the adhesion-producing mass of the carbon fibres forming a sheath, which anchors the abrasive particles and out from which the abrasive particles project. This root canal instrument structure has the advantage that it can be produced by a single injection-moulding procedure, because the adhesion-producing mass for the abrasive particles also simultaneously provides the adhesive bond for the carbon fibres.

There will now be presented hereinbelow differently structured coatings for cases when the adhesion-producing agent has a tendency to hinder the flexibility of the root canal instrument.

In such cases, the root canal instrument can preferably have at least one further uncoated region of elliptically shaped or round regions on the outer surface of the core. The effect of those elliptically shaped or round regions, which are kept free of coating, is that the coating does not substantially limit the flexibility. In addition, the cutting performance is maintained over a relatively long period, because removed tooth material blocks up the relatively large spaces of the root canal instrument relatively slowly.

Conditions for matched flexibility between the coating and core are even more advantageous when the structured metal coating comprising abrasive particles comprises circular or elliptical structures which are surrounded by regions without metal coating. As a result of this coating structure, a continuous area of coating-free core surface material is achieved, so that minimal impairment of flexibility is to be expected from this structure.

Preference is given to the coating being arranged in a helical shape on the core and helically shaped parts of the core not being coated. This helically shaped structuring has the advantage of a continuously alternating phase of coated and uncoated core surface regions in the longitudinal direction. Furthermore, such a helically shaped structuring of the coating can be produced without great manufacturing outlay. As a result of the helically shaped structure, removed tooth material is advantageously conveyed in the apical-to-distal direction.

In a further preferred embodiment of the invention, provision is made for the core to be coated in strips so that coated and uncoated strips alternate on the core surface. Finally, provision is made for the coating to surround the core in a ring-shaped or elliptically shaped arrangement, so that coated regions and uncoated regions alternate in a ring-shaped or elliptically shaped arrangement on the core in the longitudinal direction. This structure too has an advantage because an elliptically shaped ring has the additional advantage that, on rotation, there is no possibility of ring-shaped tracks grinding into the root canal.

Provision is furthermore made for the coating to comprise lozenges surrounded by two oppositely extending helically structured regions of the core without coating. A lozenge structure of such a kind can be produced very simply by means of two oppositely extending helical structures, which are introduced into a coating by means of removal of material. That removal can consist of removing, by lasers or other selective removal or dissolution methods, the adhesion-producing mass of the coating.

The orders of magnitude of the root canal instruments will now be dealt with hereinbelow, a crucial variable being the length l of such a core, because it has to extend from the crown of the tooth to the end of the root canal. With regard thereto, the length l of the root canal instrument is preferably from 10 to 40 mm. The diameter d of the core of the root canal instrument can become narrower towards the proximal end, but resulting in a diameter over the entire length of the core which preferably is from 0.1 to 3 mm. For the thickness h of the adhesion-producing mass, in which the abrasive particles are anchored, an order of magnitude of from 0.1 to 50 μm is provided. The cutting performance of a root canal instrument is highly dependent on the particle size k of the abrasive particles, the particle size k being in the range from 1 to 500 μm. The larger and/or harder the particle, the greater is the material removal rate and the roughness of the worked surface of the root canal. The smaller and/or softer the particle, the smoother and more uniform is the surface of the root canal. In the process, the adhesion of bacteria can be advantageously reduced by a high degree of polishing.

Such root canal instruments are preferably used for treating the roots of teeth. To that end, the tooth enamel is normally already partially destroyed in the upper region of the teeth so that the dentine of the tooth is exposed and it is possible to carry out treatment on the tooth through the dentine and into the root canals.

A first method for the production of a root canal instrument comprises the following method steps. First, a sub-millimetre thick core of the above-mentioned order of magnitude is produced from a nickel-titanium alloy or an electrically conductive plastics material, preferably a carbon-fibre-reinforced plastics material. There are then covered over those regions of the outer surface of the core which are to be protected from electrodeposition of an adhesion-producing mass. For that purpose preference is given to the selective application of electrically insulating lacquers. A coating a few micrometres thick of an adhesion-producing mass with abrasive particles is then deposited on those regions of the outer surface of the core which are not covered by the insulating layer. Afterwards, the insulating layer can be removed.

Such a method has the advantage that a root canal instrument can be produced in three reliable method steps, the core being produced in the first method step and the structuring being prepared in a second method step and the coating already being performed in a third method step.

An alternative method for the production of a root canal instrument comprises the following method steps. First, a sub-millimetre-sized core is again produced, but this time from fibre-reinforced electrically non-conductive plastics material. An adhesion-producing mass of a flexible layer of an adhesive or of a flexible plastics mass is then applied to partial regions of the surface of the core. Subsequently, abrasive particles are anchored in the adhesion-producing mass to the extent that they project out from the adhesion-producing mass. This method has the advantage that, depending on the properties of the layer of the adhesive or the plastics mass, which hold the abrasive particles, structuring can be provided or not. From a manufacturing point of view it is advantageous if the layer of the adhesive or plastics mass is fully matched in terms of its flexibility to the flexibility of the core so that structuring of the adhesion-imparting coating for the abrasive particles is not necessary.

In a preferred means of implementing the invention, co-extrusion or co-injection-moulding of plastics material and abrasive particles on the plastics core is carried out. The tips of the abrasive particles are then freed of the plastics material so that a high cutting capability is produced. Co-extrusion and co-injection-moulding of adhesion-producing mass and abrasive particles simplifies production and yields relatively economical root canal instruments.

Furthermore, preference is given to the production of a sub-millimetre thick core of a carbon-fibre-reinforced plastics material being carried out by means of pre-prepared compression moulds or prepregs of carbon fibres pre-coated with plastics material. Such prepregs of carbon fibres can be processed, without great manufacturing outlay, into sub-millimetre thick cores, to which an appropriate coating with abrasive particles can then be applied.

A further example of implementing the method provides for an adhesion-producing mass of a flexible layer of an adhesive being produced by immersion of the fibre-reinforced plastics core in a solution of an adhesive. Abrasive particles can then be applied by rolling the adhesive-coated core in a particle powder, which particles are anchored in the adhesive as a result of full hardening of the latter. This method too is suitable for mass production.

The methods explained hereinbefore are based on a round core, which preferably becomes narrower towards the proximal end. The following method example is based on a basic plate, which is first coated and is then cut into suitable strips, which can then in turn be finished by means of twisting to form coated root canal drill bits. For this purpose, the method for the production of a root canal instrument comprises the following method steps. First, a sub-millimetre thick basic plate of a titanium-nickel alloy or of a fibre-reinforced plastics material is produced. The basic plate is then provided with a coating comprising abrasive particles. Finally, the basic plate is divided up into longitudinally extending strips of four-sided or three-sided cross-section in such a manner that narrow sides of the four-sided cross-sections or one side of the three-sided cross-sections have/has the coating. Then, twisting of the strips is carried out to form a root canal drill bit having cutting edges comprising abrasive particles. This method has the advantage that it yields root canal drill bits according to the invention which are a match for chromium steel drill bits in respect of their cutting performance and yet are sufficiently flexible for introduction into a root canal.

The four-sided cross-sections preferably comprise a rectangle or a parallelogram. The parallelogram is formed when the dividing line is introduced into the coated basic plate not vertically with respect to the surface but at a slant or on an inclination with respect to the surface. After division, the strips having a cross-section in the form of a rectangle and/or a parallelogram and/or a triangle can be twisted, the parallelogram having the advantage that it yields clearly salient cutting edges when twisted.

For the purpose of coating the basic plate, the plastics mass comprising abrasive particles can be applied on both sides so that the cutting performance of the root canal drill bit is further improved. For coating, electrodeposition can be performed on the sub-millimetre plate in an appropriate electrolyte bath. This has the advantage that coating is simultaneously possible for a large number of root canal drill bits. The mean particle size k of the abrasive particles in that case is in the range from 1 to 500 μm. Division of the prepared basic plate into longitudinally extending strips is preferably carried out by means of high-speed saws having air bearings and diamond saw blades having a thickness of up to 100 μm and a cutting depth t where t is up to 1 mm.

### BRIEF DESCRIPTION OF THE DRAWINGS

The invention will now be explained with reference to the accompanying Figures.

FIG. 1 is a schematic diagram of a root canal instrument according to a first embodiment of the invention in use.

FIG. 2 is an enlarged schematic diagram of the root canal instrument according to FIG. 1.

FIG. 3 is a schematic diagram of a root canal instrument according to a second embodiment of the invention.

FIG. 4 is a schematic diagram of a root canal instrument according to a third embodiment of the invention.

FIG. 5 is a schematic diagram of a root canal instrument according to a fourth embodiment of the invention.

FIG. 6 is a schematic diagram of a root canal instrument according to a fifth embodiment of the invention.

FIG. 7 is a schematic diagram of a root canal instrument according to a sixth embodiment of the invention.

FIG. 8 is a schematic diagram of a root canal instrument according to a seventh embodiment of the invention.

FIG. 9 shows a diagrammatic cross-section through the root canal instrument according to FIG. 8 along the line of section A-A in FIG. 8.

FIG. 10 shows a diagrammatic cross-section through a variant of the root canal instrument according to FIG. 8 along the line of section A-A in FIG. 8.

FIG. 11 shows a diagrammatic cross-section through a further variant of the root canal instrument according to FIG. 8 along the line of section A-A in FIG. 8.

FIG. 12 is a schematic diagram of a root canal instrument according to an eighth embodiment of the invention.

### DETAILED DESCRIPTION OF THE INVENTION

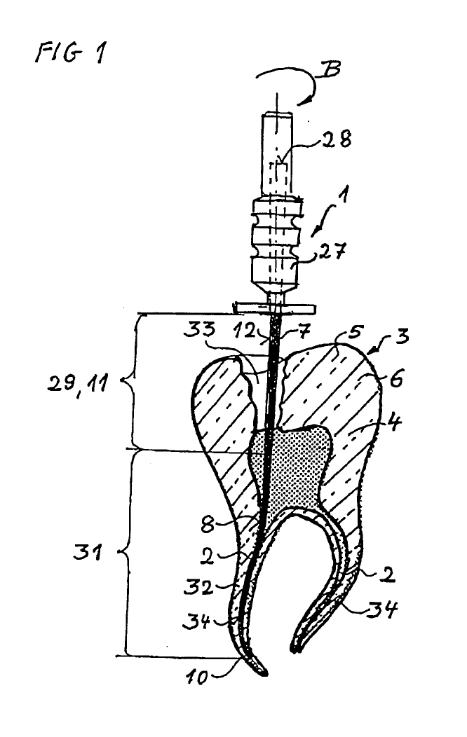

FIG. 1 is a schematic diagram of a root canal instrument 1 according to a first embodiment of the invention in use. The root canal instrument 1 has a push-in coupling 27 to a drive device (not shown), which brings about torque-protected rotation of the push-in coupling 27 in the direction of rotation B. The root canal instrument 1 furthermore has a thin core 7, which becomes narrower towards the proximal end 10 of the root canal instrument 1. The distal end 28 of this core 7 is embedded in the material of the push-in coupling 27 by means of a shape-based and friction-based connection. In an upper, distal region 29, the outer surface 12 of the core 7 is uncoated, and in a lower, proximal region 31 the core 7 has a coating 8 with abrasive particles.

A root canal instrument 1 of such a kind is guided through an opening 33 in the tooth enamel 5 of the crown 6 of a tooth 3 and through the dentine 4 to a tooth root 34, and, by virtue of its high flexibility, it follows the curvature of the root canal 2 of the tooth. For that purpose, the proximal end 10 of the root canal instrument 1 remains free of a coating 8 with appropriate abrasive particles, in order to ensure that the proximal end 10 of the root canal instrument 1 guides the lower, proximal region 31 of the core 7, which region is occupied by abrasive particles, through that material of the tooth root canal 2 which is softer than the tooth cementum 32, along the curvature of the canal, without prematurely penetrating through the surrounding dentine 4 and tooth cementum 32 as a result of the rotatory and grinding movement of the root canal instrument 1 and not following the curvature of the root canal 2.

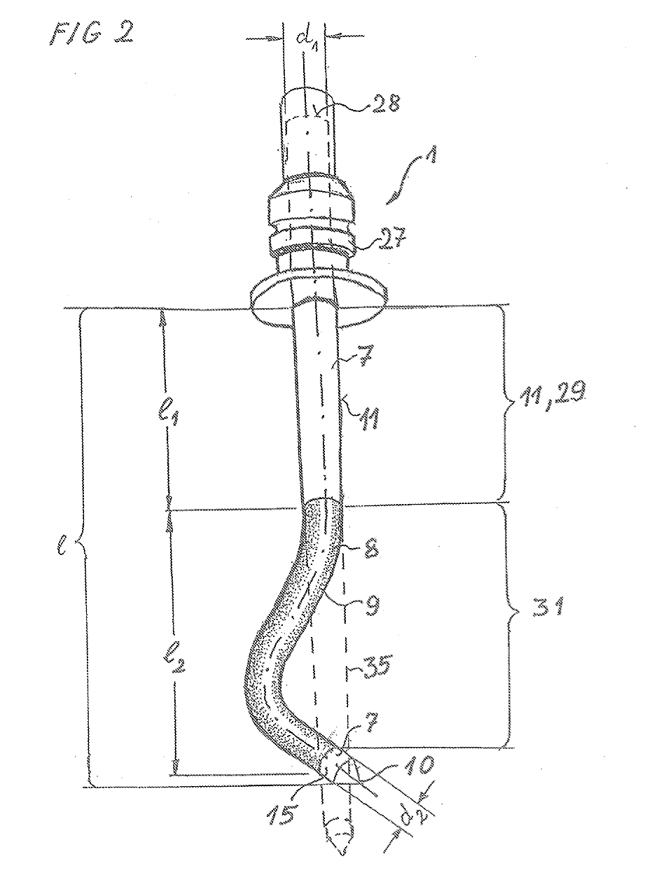

FIG. 2 is an enlarged schematic diagram of the root canal instrument 1 according to FIG. 1. In the case of this root canal instrument 1, the upper, distal region 29 of the core 7 is free of a coating 8 with abrasive particles 9 over a length l₁ of the overall length l of the core 7 of the root canal instrument 1. The diameter d₁ at the distal end 28, which is embedded in the push-in coupling 27, is from 0.1 to 3 mm. The coating-free region 11 in the upper, distal region 29 has a length l₁ of about 5 mm, whereas the region occupied by abrasive particles has a length l₂ of preferably from 0.5 to 25 mm. The core 7 narrows towards the uncoated region 15 of the proximal end 10 to a diameter d₂, the diameter d₂ being from 0.1 to 1.2 mm.

In this first embodiment of the invention, the core 7 is made from a carbon-fibre-reinforced plastics material, the plastics material on the outer surface 12 of the core 7 in the lower, proximal region 31 anchoring the abrasive particles 9 in such a way that they project out from the outer surface 12 of the plastics material. The plastics material, which holds the carbon fibres of the core together, accordingly serves at the same time for anchoring abrasive particles 9 on the outer surface 12 in the lower, proximal region 31 of the root canal instrument 1. By that means it is ensured that the flexibility of the coating 8 with abrasive particles 9 is optimally matched to the flexibility of the core 7.

The curvature, visible in FIG. 2, of the lower, proximal region 31 of the core 7 coated with abrasive particles follows the curvature of a root canal; it does not show the root canal instrument 1 in its position of rest. In its position of rest, by virtue of the superelasticity of the carbon fibres, the root canal instrument 1 returns to its original longitudinally extended rectilinear shape indicated here by the broken line 35.

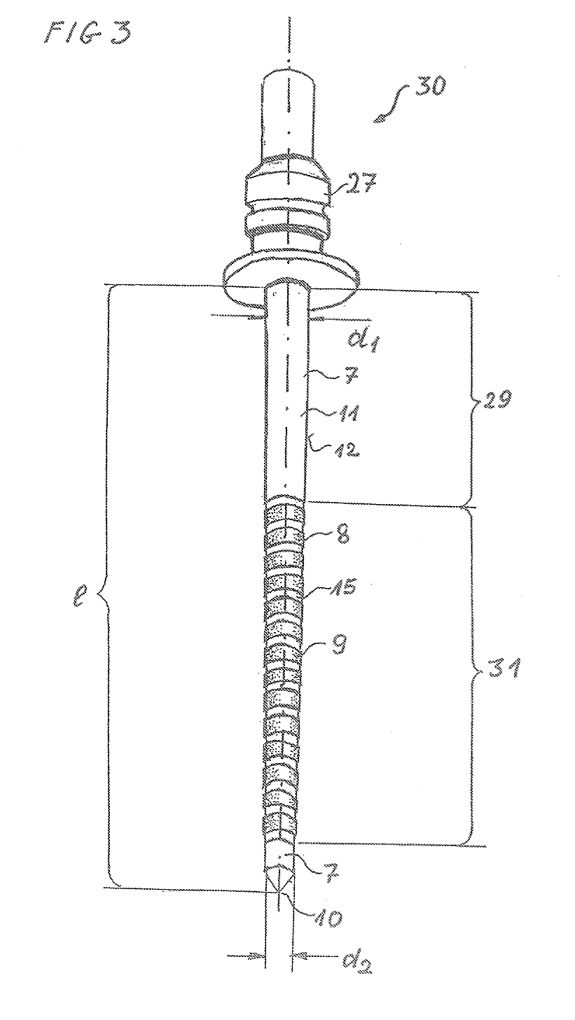

FIGS. 3 to 8 show different embodiments of the invention, especially in respect of the structuring of the coating 8 in the lower, proximal region 31 of the root canal instrument 1. Components having the same functions as in FIGS. 1 and 2 are marked with the same reference symbols in FIGS. 3 to 8 and are not separately explained.

FIG. 3 is a schematic diagram of a root canal instrument 30 according to a second embodiment of the invention. This root canal instrument 30 has a core 7 which consists of an electrically conductive material.

This electrically conductive material can be a nickel-titanium alloy, which comprises about 45% nickel by weight and about 55% titanium by weight and which is distinguished by its superelasticity, which is characterised in that, in addition the Hooke's elasticity, as chromium carbon steels are known to have, an additional elasticity due to the shape memory of this alloy also comes into play, wherein temporarily as a result of mechanical loading caused by deformations a hexagonal structure called martensite forms in the cubic host structure called austenite, the martensitic structure re-forming again into the host structure on unloading.

As an adhesion-producing agent for the abrasive particles 9, a metal coating can be electrodeposited on such metallic materials for the core 7, the abrasive particles 9 being deposited on the outer surface 12 of the core 7 at the same time as the electrodeposition. In order to achieve the ring-shaped structure of deposited coating which is shown in FIG. 3, the uncoated regions 15, which are likewise ring-shaped in this embodiment, can be protected with an insulating layer in the electrodeposition bath. The insulating layer can subsequently be removed after deposition of the ring-shaped structured coating 8.

Instead of a metallic core 7, a core 7 of plastics material can also be prepared for electrodeposition, either by coating the outer surface 12 with conductive particles by, for example, sputtering or by including a filler of metallic particles such as silver with the plastics material and thereby making an electrically conductive core 7. Instead of the circular rings of the structured coating 9 in FIG. 3, elliptically shaped rings can also be deposited on the surface 12 of the core.

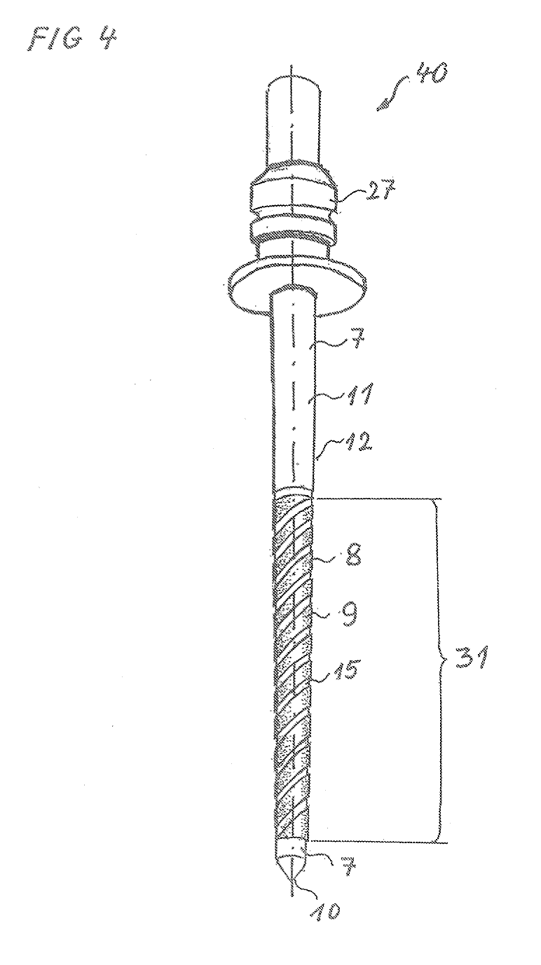

FIG. 4 is a schematic diagram of a root canal instrument 40 according to a third embodiment of the invention. In this case the flexibility of the coating 8 is matched to the flexibility of the core 7 by means of a helically shaped coating 8 structure. A helically shaped coated structure accordingly alternates with helically shaped uncoated regions 15 in the lower, proximal region 31 of the root canal instrument 40.

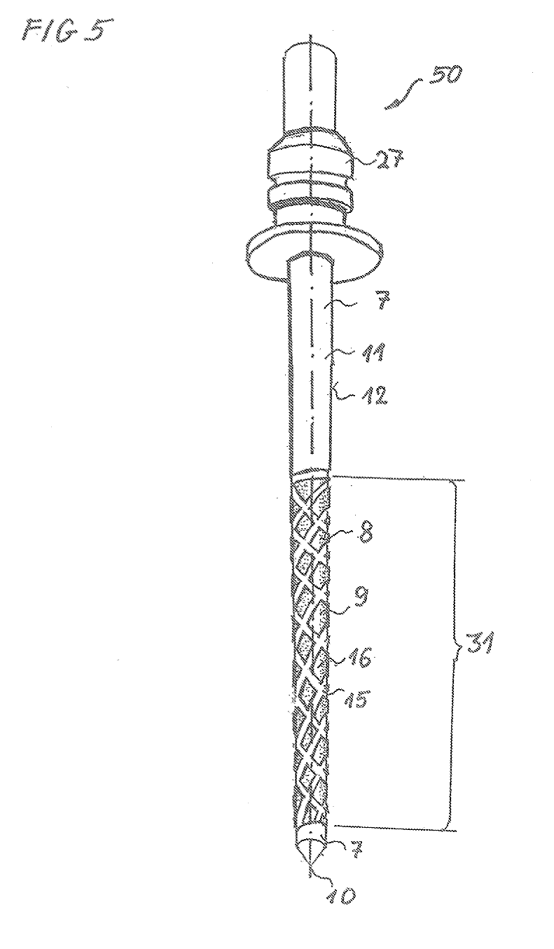

FIG. 5 is a schematic diagram of a root canal instrument 50 according to a fourth embodiment of the invention. In this embodiment, the coating 8 has been so structured that lozenges 16 are occupied by abrasive particles, which are surrounded by two oppositely extending helically shaped uncoated regions 15. This pattern of lozenges 16 can be produced by means of suitable preparation as has already been discussed for FIG. 4.

FIG. 6 is a schematic diagram of a root canal instrument 60 according to a fifth embodiment of the invention. In this embodiment of the invention, elliptically shaped islands 13, which are surrounded by regions without coating 15, are occupied by abrasive particles. In this case the uncoated regions 15 form a continuous region, which improves the flexibility of this embodiment of the invention.

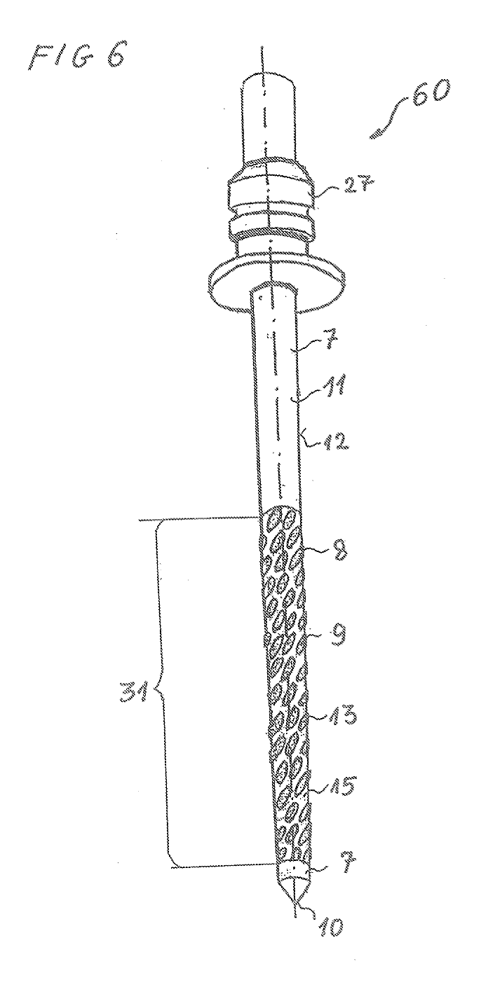

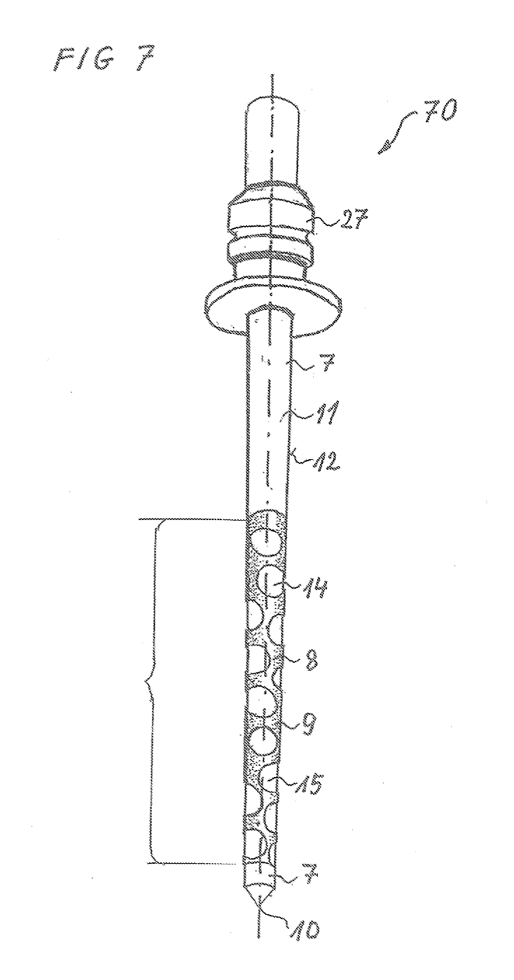

FIG. 7 is a schematic diagram of a root canal instrument 70 according to a sixth embodiment of the invention. In this sixth embodiment of the invention, circular round regions 14 within the coating 8 have been kept free of particle coating. The flexibility of the coating 8 can likewise be matched to the flexibility of the core 7 by means of these uncoated circular regions 14.

In principle, mixed forms of the coating structures as shown in FIGS. 2 to 7 are also possible.

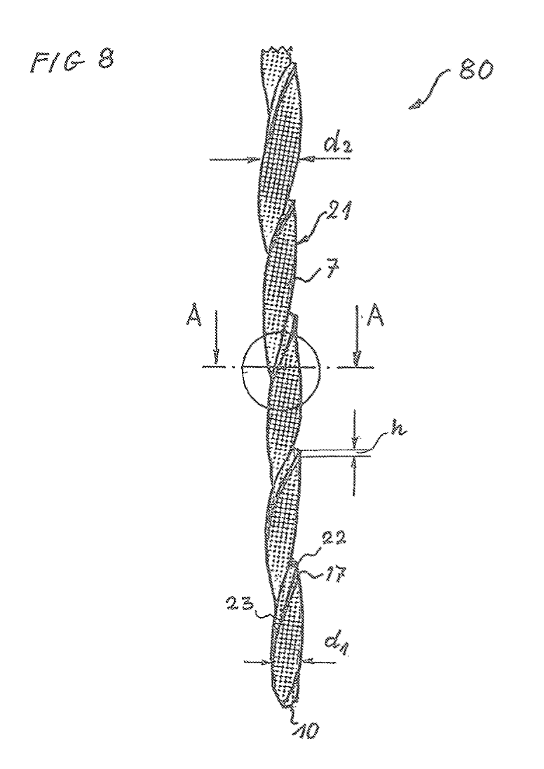

FIG. 8 is a schematic diagram of a root canal instrument 80 according to a seventh embodiment of the invention. In this case, production of the core 7 does not start from a prefabricated conical rod which narrows towards the proximal end 10 as the core but rather starts from a basic plate produced using a core material such as nickel-titanium alloy and/or a plastics material. The basic plate is coated on one side or on two sides with an adhesion-producing mass 17 comprising abrasive particles. This basic plate can subsequently be divided into strips of rectangular or parallelogram-shaped or triangular cross-section. As a result of twisting the strips, the root canal instrument 80 shown in FIG. 8, having a root canal drill bit 21, can be produced. In principle it is also possible first to produce the strips from an uncoated nickel-titanium plate and then to carry out coating and finally to twist the strips or bars.

For the purpose there is used, in the case of a carbon-fibre-reinforced plastics basic plate, a thermoplastic material, which is heated up for the purpose of twisting after the strips have been produced. When twisting a metallic strip of a nickel-titanium alloy, this is likewise heated up in order to retain the austenitic structure. As a result of coating of the basic plate with an adhesion-producing mass including a filler of particles 17, in a thickness h of from 0.5 to 50 μm, this root canal drill bit 21 gives rise to a root canal instrument 80, which has abrasive particles on its cutting edges 22 and 23.

FIG. 9 shows a diagrammatic cross-section through the root canal instrument 80 along the line of section A-A in FIG. 8. The four-sided cross-section 18 in the shape of a rectangle 24 having the narrow sides 19 and 20 arises as a result of dividing the basic plate up into individual strips, with sawing being carried out in a perpendicular direction to the coatings 8. In order that both narrow sides 19 and 20 can be occupied by abrasive particles 9, the basic plate is coated on two sides with an adhesion-producing mass 17 comprising abrasive particles 9. The adhesion-producing mass 17 can be a bronze layer 26, in which the abrasive particles 9 are embedded. As a result of the abrasive particles 9, the cutting edges 22 and 23 become effective on rotation of the root canal drill bit 21 in the direction of arrow C, while in the opposite direction D the cutting edges 36 and 37 located opposite bring about removal of material.

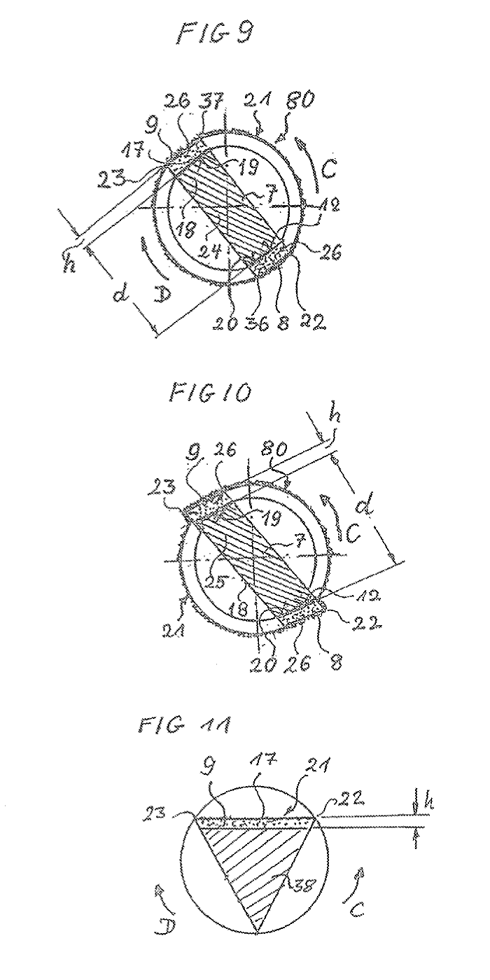

FIG. 10 shows a diagrammatic cross-section through a variant of the root canal instrument 80 according to FIG. 8 along the line of section A-A in FIG. 8. Components having the same functions as in FIG. 9 are marked with the same reference symbols and are not separately explained.

The difference in the case of this variant lies in the four-sided cross-section 18 of the core of the root canal drill bit 21. This cross-section comprises a parallelogram 25, which arises as a result of the basic plate, having been coated on two sides with an adhesion-producing mass 17, being divided up into strips at an angle of inclination with respect to the coatings. In this embodiment of the invention, a cutting action of the root canal drill bit 21 is obtained solely in the direction of rotation C, in which the cutting edges 22 and 23 with their abrasive particles 9 promote the removal of material.

In their material removal action, such root canal drill bits 21 provided with abrasive particles 9 on their cutting edges 22 and 23 surpass those root canal drill bits made of a nickel-titanium alloy which are known from the prior art and which, because of their reduced Vickers hardness, have disadvantages in their material removal rate compared to chromium carbon steels. Accordingly, this root canal instrument combines, in ideal manner, the high flexibility of nickel-titanium alloys and/or of plastics materials with the high cutting and polishing capability of abrasive particles to form a new, highly effective root canal instrument.

FIG. 11 shows a diagrammatic cross-section through a variant of the root canal instrument 80 according to FIG. 8 along the line of section A-A in FIG. 8. Components having the same functions as in FIG. 8, 9 or 10 are marked with the same reference symbols and are not separately explained.

The difference in the case of this third variant lies in the triangular cross-section 18 of the core of the root canal drill bit 21. This cross-section comprises a triangle 38, which arises as a result of the basic plate, having been coated on two sides with an adhesion-producing mass 17, being divided up into strips at two angles of inclination with respect to the coatings. In this embodiment of the invention, a cutting action of the root canal drill bit 21 is obtained both in the direction of rotation C and also in the direction of rotation D, in which the cutting edges 22 and 23 with their abrasive particles 9 promote the removal of material.

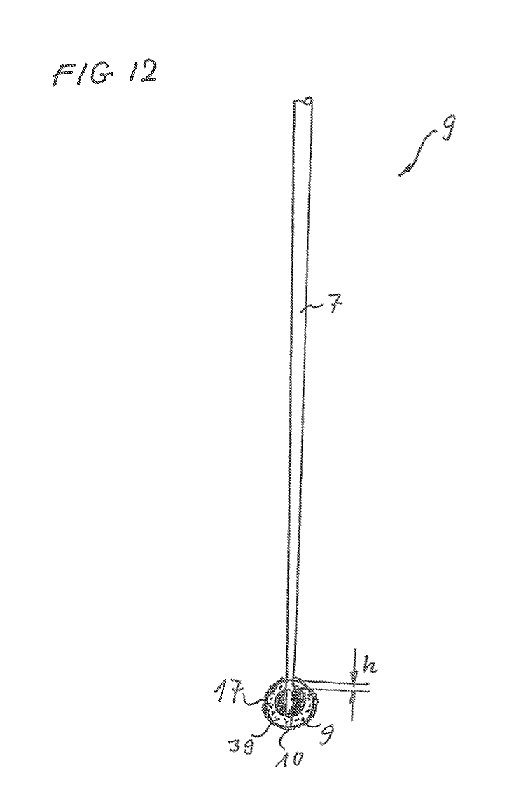

FIG. 12 is a schematic diagram of a root canal instrument 90 according to an eighth embodiment of the invention. The root canal instrument 90 has a core (7) of a flexible elastic material having shape memory. At its proximal end 10 there is arranged a grinding or polishing body 39, which comprises abrasive particles 9. This grinding or polishing body 39 is a part of the core (7) or is screwed, bonded, soldered or welded to the core 7 or is electrodeposited on the proximal end 10 of the core 7 or applied to the proximal end 10 by means of injection-moulding technology.

### LIST OF REFERENCE SYMBOLS

1 root canal instrument
2 root canal
3 tooth
4 dentine
5 tooth enamel
6 crown of tooth
7 core
8 coating
9 abrasive particles
10 proximal end
11 further uncoated region
12 outer surface of core
13 elliptically shaped island
14 round region
15 region without coating
16 lozenge
17 adhesion-producing mass
18 four-sided cross-section
19 narrow side
20 narrow side
21 root canal drill bit
22 cutting edge
23 cutting edge
24 rectangle
25 parallelogram
26 bronze layer
27 push-in coupling
28 distal end
29 upper, distal region
30 root canal instrument (second embodiment)
31 lower, proximal region
32 tooth cementum
33 opening
34 tooth root
35 broken line
36 cutting edge
37 cutting edge
38 triangle
39 grinding or polishing body
40 root canal instrument (third embodiment)
50 root canal instrument (fourth embodiment)
60 root canal instrument (fifth embodiment)
70 root canal instrument (sixth embodiment)
80 root canal instrument (seventh embodiment)
90 root canal instrument (eighth embodiment)
A-A line of section
B direction of rotation
C direction of rotation
D direction of rotation
d diameter of core
d₁ diameter of core at the distal end
d₂ diameter of core at the proximal end
h thickness of the adhesion-producing mass
l length of the core
l₁ length of the core in the distal region
l₂ length of the core in the proximal region

What is claimed is:

1. A method of making a root canal instrument, the method comprising steps of:
(a) making a basic plate having a thickness of less than one millimeter, the basic plate comprising a titanium-nickel alloy, a plastics material, or a carbon-fiber reinforced plastic material;
(b) coating the basic plate with a coating comprising abrasive particles;
(c) dividing the basic plate into a plurality of longitudinally extended strips, at least one strip comprising a cross-section having three exterior surfaces or four exterior surfaces, the at least one strip comprising the coating disposed on at least one exterior surface;
(d) twisting the at least one strip to form a root canal drill bit comprising a cutting edge having abrasive particles disposed on the cutting edge.

2. The method of claim 1, wherein step (c) is performed at least partially by
setting a high-speed diamond saw orthogonally or on a slant relative to an upper surface of the basic plate, the saw forming a rectangle, a triangle, or a parallelogram.

3. The method of claim 1, wherein the coating comprises a plastics mass with the abrasive particles.

4. The method of claim 1, wherein the coating comprises a bronze layer with the abrasive particles and wherein step (b) is performed at least partially by electrodeposition on the basic plate when it comprises an electrically conductive material.

5. The method of claim 1, wherein the abrasive particles comprise a mean particle size in a range of 1 to 500 micrometers and being anchored in coating.

6. The method of claim 1, wherein step (c) is performed partially by
using a high-speed saw having air bearings and diamond saw blades of a thickness less than or equal to 100 micrometers and a cutting depth of up to 1 millimeter.

7. A root canal instrument comprising:
a twisted strip comprising a titanium-nickel alloy or a plastics material, the strip comprises a cross-section having plurality of exterior surfaces; and
a coating disposed on at least one exterior surface, the coating comprising abrasive particles.

8. The root canal instrument of claim 7, wherein the coating further comprises an adhesion-producing mass, the adhesion-producing mass comprising a plastics mass having the abrasive particles or a bronze layer having the abrasive particles.

9. The root canal instrument of claim 8, wherein the adhesion-producing mass comprises a thickness of 0.5 to 50 micrometers.

10. The root canal instrument of claim 7, wherein the abrasive particles comprise a mean particle size in a range of 1 to 500 micrometers.

11. The root canal instrument of claim 7, wherein the plurality of exterior surfaces forms a rectangle or a parallelogram in cross-section.

12. The root canal instrument of claim 7, wherein the plurality of exterior surfaces forms a rectangle in the cross-section and wherein the two exterior surfaces having least dimensions in the cross-section comprise the coating.

13. The root canal instrument of claim 7, wherein the plurality of exterior surfaces forms a parallelogram in the cross-section and wherein two opposing exterior surfaces comprise the coating.

14. The root canal instrument of claim 7, wherein the plurality of exterior surfaces form a triangle in the cross-section.
